(19) United States
(12) Patent Application Publication
(10) Pub. No.: US 2004/0131023 A1
(43) Pub. Date: Jul. 8, 2004

(54) Communications system and method

(76) Inventor: Otso Auterinen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/336,038

(22) Filed: Jan. 3, 2003

(51) Int. Cl. H04Q 7/00; H04L 12/28

(52) U.S. Cl. 370/328; 370/401

(57) ABSTRACT

This invention relates to a communication system, which includes at least one first network and at least one second network. At least one user equipment attaches to a first network and a device allows the at least one user equipment to access a service via a second network.

### FIELD OF THE INVENTION

The present invention relates to a communications system and method and in particular but not exclusively to a communication system and method in a packet switched environment.

### BACKGROUND OF THE INVENTION

A communication system can be seen as a facility that enables a user thereof to communicate with one or more other entities such as another user equipment and/or nodes implemented within the communication system. The communication may comprise, for example, communication of voice, data, multimedia and so on.

Cellular telecommunication networks are known, where the area covered by the network is divided into a plurality of cells. Each cell is provided with a base station which is arranged to communicate with mobile station in the cells using a wireless connection.

A communication system typically operates in accordance with a given standard or specification which sets out what the various elements of the system are permitted to do and how they should be achieved. For example, the standard or specification may define if the user, or more precisely, user equipment or terminal is provided with a circuit switched service and/or a packet switched service. Communication protocols and/or parameters, which should be used for the connection, may also be defined. In other words, a specific set of “rules”, on which the communication can be based on, needs to be defined to enable communication by components of the system.

There are a number of different standards which govern the communication between mobile stations and base stations as well as with other network elements. One example of a currently known standard is the GSM standard (Global System for Mobile Communications). At the present time, work is being carried out on the so called third generation standard. One example of these third generation standards is the UMTS (Universal Mobile Telecommunications System) Standard. In general, the third generation standards use code division multiple access in the radio interface between mobile stations and base transceiver stations.

Increasingly, there is more and more convergence between internet protocol (IP) based systems such as the World Wide Web or the Internet and wireless based communication systems. Currently, it is proposed in at least some third generation standards to use the IP in the radio access network (RAN).

The users of a communication system may be provided with a possibility to use various services. The services are typically provided by entities referred to as service providers. The services provided for a user may comprise any service that can be provided by means of the communication system. For example, and without any intention to limit to these, a user may be provided with a possibility to make and receive calls, to browse data networks (e.g. the Internet), to send and receive e-mails or other text messages, to receive various types of content from a server (e.g. video data or other image or voice data), to attend chat rooms, to use various other value added services such as the presence service, location based services, or to attend games, competitions, voting services, and so on.

To use a service, generally a user has to connect to an access point which is available to the user via the network to which the user is currently attached. Services are often provided by service providers who are different to the operator of the network to which the user is attached. The service providers are often external to the network. As mentioned, a user is only able to obtain a service which is available to the network. For example, a gateway node of a network is often connectable to an access point node through which a service is available. Therefore, a need exists to provide better services to a user whom is currently not able to access services which are only available via a network to which the user is not currently attached. This limits the services available to the user or requires a large number of agreements between service providers and network operators.

### SUMMARY OF THE INVENTION

According to a first aspect of the present invention, provided is a communication system including at least one first network and at least one second network. The communication system also provides at least one user equipment attached to a first network and means for allowing the at least one user equipment to access a service via a second network.

According to a second aspect of the present invention, provided is a method of communication in a system comprising at least one first network and at least one second network. The method includes the steps of attaching at least one user equipment to a first network and allowing the at least one user equipment to access a service via a second network.

According to a third aspect of the present invention, provided is an apparatus for use in a communications system including a first network and a second network. The apparatus is configured to be connected to the first network and the second network. The apparatus is further configured to permit a user attached to one of the first and second networks to access a service provided by another of the first and second networks.

### BRIEF DESCRIPTION OF DRAWINGS

For a better understanding of the present invention and as to how the same may be carried into effect, reference will now be made by way of example only to the accompanying drawings in which:

FIG. 1 shows a typical cellular telecommunications network with which embodiments of the present invention can be used;

FIG. 2 shows a schematic view of an embodiment of the present invention;

FIG. 3 shows a first signal flow embodying the present invention; and

FIG. 4 shows a second signal flow embodying the present invention.

### DETAILED DESCRIPTION OF EMBODIMENTS OF THE INVENTION

Reference is first made to FIG. 1 which shows a cellular communications network 2 in which embodiments of the present invention can be incorporated. The area covered by the network is divided into cells 4. Each cell is provided with a base transceiver station 6. The base transceiver station 6 is arranged to communicate with user equipment 8. Where the user equipment is in a location served by more than one base station, one or even several of the base transceiver stations may serve that user equipment. The user equipment may be, for example, a mobile telephone, computer or personal digital assistant. The user equipment may be fixed or mobile.

Embodiments of the present invention are particularly applicable to systems using packet switched technologies. One example of such a technology is the general packet radio service (GPRS) which can be implemented as part of a third generation standard such as the (UMTS) universal mobile telecommunications system or part of the GSM systems. Embodiments of the invention are not however limited to packet switched technology and can be used with a circuit switched technology. Embodiments of the invention can be used with an IP based technology.

Embodiments of the present invention are arranged to provide service roaming. This concept is not disclosed in the current third generation proposals.

In this document, the term service roaming is used to describe access to an access point which is not in the PLMN (public land mobile network) to which the user is currently attached. In the preferred embodiments of the present invention, service roaming refers to GPRS access to a GPRS access point. Generally, the user will be in one network while accessing an access point via a different network when doing service roaming.

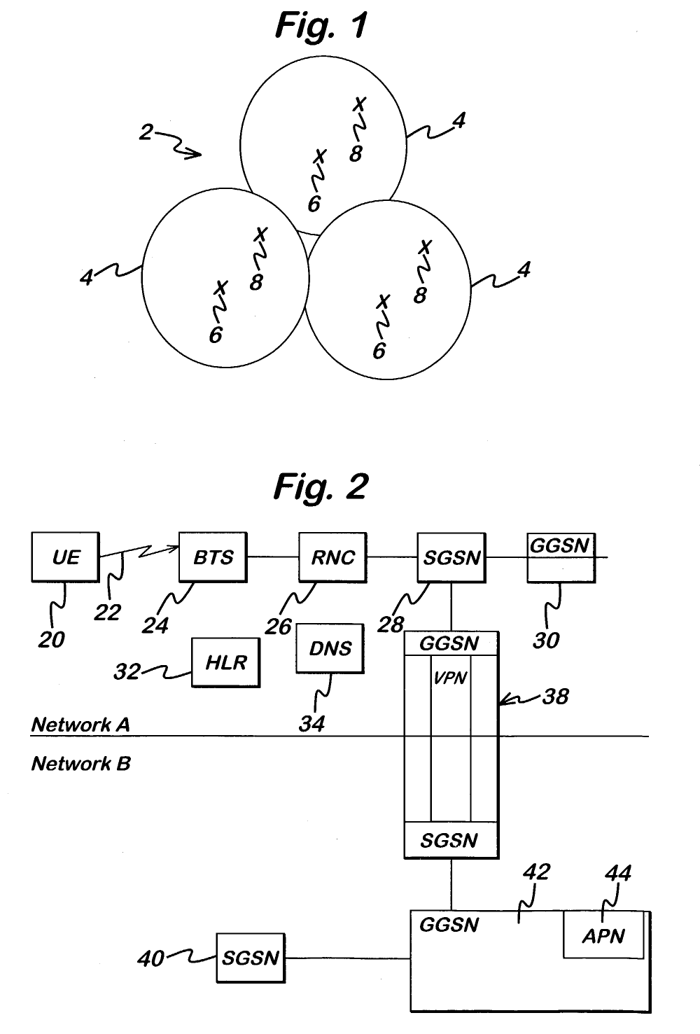

Reference is made to FIG. 2 which shows an embodiment of the present invention. User equipment 20 is arranged to communicate via an interface 22 with a base transceiver station 24. The connection between the user equipment and the base station will be a wireless connection, typically but not necessarily at a radio frequency.

The base transceiver station 24 is connected to a radio network controller RNC 26. The radio network controller 26 owns and controls the radio resources in its domain, that is, the base transceiver stations 24 connected to it. Typically the RNC 26 is arranged to control more than one base station. The radio network controller 26 is the service access point for all services that the UTRAN (UMTS terrestrial radio access network) provides the core network. The UTRAN is made up of the base transceiver stations and RNC. Examples of the services provided by UTRAN to the core network include management of the connections to the user equipment.

In embodiments of the present invention, the core network is made up, for example, of an SGSN (Serving GPRS Support Node) 28 and GGSN (Gateway GPRS Support Node) 30. The SGSN is used for packet switched services. In particular, it is the switch which serves the user equipment in its current location for packet switched services. The SGSN function is used to switch the packet switched transaction. The part of the network which is accessed by the SGSN is often referred to as the packet switched domain.

The GGSN 30 is the switch at the point where the UMTS PLMN is connected to external packet switched networks. All incoming and outgoing packet switch connections go through the GGSN 30.

Also provided in the network is a home location register 32. The home location register 32 can be accessed via various entities including the SGSN 28 and the GGSN 30. The home location register HLR 32 is a data base located in the user home network that stores the master copy of the users service profile. Typically, the service profile consists of, for example, information on allowed services, forbidden roaming areas and supplementary service information, such as status of call forwarding and the call forwarding number. It is created when a new user subscribes to the system and remains stored as long as the subscription is active. For the purpose of routing incoming transactions to the user equipment such as calls or messages, the HLR also stores the user equipment on the level of the SGSN.

Additionally, a domain name server DNS 34 may also be provided. All of these elements are provided in network A which is the home network of the user equipment or the network to which the user equipment is currently attached. In some embodiments of the invention, the DNS may be omitted.

In embodiments of the present invention, a GGSN exchange node 38 is provided. This node 38 affectively provides a gateway between network A and network B. The GGSN exchange 38 will be described in more detail later.

Network B has an SGSN 40, and a GGSN 42 providing an access point 44 to the network. The access point 44 provides a service which the user 10 desires to access. The network B has similar elements to those of network A in addition to the SGSN 40 and GGSN 42. However, for clarity's sake, these elements are omitted.

The GGSN exchange 38 is used for service roaming. When the user equipment 20, which is in network A, wants to access a service provided by the access point 44 of the GGSN 42, which is in network B, the GGSN exchange 38 is used. A PDP (Packet Data Protocol) context activation is directed to the GGSN exchange 38. The GGSN exchange 38 receives a PDP context activation request from network A from the SGSN 28. When the GGSN exchange 38 receives the PDP context activation request, the GGSN exchange 38 is arranged to carry out a set of checks. It should be appreciated that the GGSN exchange 32 appears as the GGSN for some access point names in network A.

First, the authorization of the user for the access point is checked. In other words, it is checked whether or not the user of the user equipment 20 can obtain the service from the access point 44.

Second, the admission control to apply the service level agreement (SLA) with the operator of network A is checked. In other words, it is checked to see whether or not users of network A are permitted by the operator of network A to use the service provided by access point 44. Additionally the admission control also involves accepting the admission of the user as such and/or detecting a need to negotiate the service level requested by the user equipment. This allows network A to have a role in deciding the service level. The final network A decision may depend on the feedback from network B.

Third, the admission control to apply the service level agreement with the network B operator is checked. In other words, it is checked to see whether or not a user in network A is permitted by the operator of network B to obtain services provided by the access point 44. The service level may be decided based on information passed by the user equipment UE and network A (the GGSN exchange part operating for network A).

Finally, the GGSN exchange 38 checks the admission control based on the local resource management of the GGSN exchange 38 to ensure resources are available in the GGSN exchange and the link capacity at the interface of the GGSN exchange 38. In other words, the GGSN exchange 38 checks to see whether or not the resources are available to provide the service from the access point 44.

The first three checks require the GGSN exchange 38 to access a database. This database may be part of the GGSN exchange, contained in, for example, network A, or be an external database. Information from the home location register 32 may be passed by the SGSN to the GGSN exchange. The database for the admission control decision by the GGSN exchange may appear as a single entity or, for example, as a distributed entity with two units, one for network A and one for network B. Additionally, there may be a third unit (or man in the middle) representing the outside control in admission control. The GGSN exchange may access more than one database to obtain the required information. In particular, the database or databases, which are accessed, contain information about the subscriber to service relationship, about the service level agreement with the operator of network A and about the service level agreement with operator B. For the final check, the GGSN exchange 38 may use the service preference implied directly or indirectly from the information used in the first three checks.

A management interface may be provided for the operator of network A which is used to control the service level agreement. Similarly, there is a management interface for the operator of network B, which is also used to control the service level agreement. The management interface may keep the database updated. The admission control decision may be policy, that is rules and roles, based where the policy is described in a database and applied by the GGSN exchange.

For authorization, the operator of the GGSN exchange maintains user profiles, services profiles and rules. The parameters used for making decisions by GGSN exchange such as user profiles, service profiles, and rules can be used for authorization and admission control. As described above, the database can include a unit operating for network B. This database (or profiles or the like) may also control the decisions and operations of GGSN 42 of network B.

The GGSN exchange forwards the PDP context activation to the GGSN of network B which serves the access point. The GGSN exchange may provide the same functionality as a GGSN, as far as network A is concerned, and provide a SGSN functionality, as far as network B is concerned. The connection between the two ends of the GGSN exchange 38 may be via a virtual private network connection or may be provided by any mechanism which enables the two halves of the GGSN exchange to operate. Thus the connection can be provided in any suitable way. For example, the connection can be provided by a GPRS roaming exchange node (GPX).

It should be appreciated that in preferred embodiments, the GGSN exchange 3 8 may be provided by a single entity or may be provided by two or more entities acting to provide the GGSN exchange functionality. Where the GGSN functionality is provided by two or more entities, at least one entity may be provided in network A, and at least one entity provided in network B.

In one embodiment of the invention, the GGSN exchange is used only for the control plane, and the user plane flows directly between SGSN 28 and GGSN 42, as defined by the Gn/Gp reference point in the 3GPP (Third Generation Partnership Project) specification. Alternatively, the GTP-U (User plane of the GPRS Tunneling Protocol) is also processed by the GGSN exchange. This alternative is used when user payload transmitted as GTP-U packets are needed because of inspection (statistics/charging) or manipulation (virtual identity: mapping the IMSI), or because of the need to hide the details of the two IP networks. The GGSN exchange is like an application proxy GTP-protocol.

The GGSN of network B transfers the PDP context activation response to the GGSN exchange. The GGSN exchange can forward the activation request and response to indicate to the GTP-C (GTP control plane is routed via the GGSN exchange or it may advise SGSN 40 in the activation response to communicate directly with GGSN 42) that a direct GTP-C be set up between the SGSN 40 and GGSN 42 in network B. GTP-C routing via the GGSN exchange may be used, for example, to maintain control over the PDP context and to enable billing in the GGSN exchange.

Accordingly, in preferred embodiments of the present invention, a tunnel or the like is set up between the SGSN of network A and the GGSN exchange 38. In particular, the SGSN of network A is connected to the GGSN part of the GGSN exchange 38. The connection then passes to the SGSN part of the GGSN exchange. A connection is then made to the GGSN 42 of network B which is arranged to communicate with the access point node. In some embodiments of the present invention, the access point node may be part of the GGSN of network B.

In a service roaming environment, the questions about customization and privacy may become even more important than the case where the user uses services provided by the mobile operator who has a subscription based relationship with an end user. Service roaming allows a rich set of attributes describing the static and dynamic properties of the subscriber and the way that the subscriber uses the access network. This is referred to in this document as access attributes. A particular case of access attributes is called an access case. The attributes, which are not static for a subscriber, make up the use context of an individual user. In other words, a pattern can be built up of the preferences and movement of the user. The access case is a set of information available at the edge of an access network. The applications accessed from the mobile network may benefit to this information. However, this has to be balanced with the business objectives of the access operator and the privacy needs of the subscriber. In embodiments of the present invention, it is possible for the user to access the access point node with an identity which does not identify the user. This will be described in more detail hereinafter.

In one embodiment of the present invention, the domain name server in network A contains for a given access point node in network B an IP address. The address of the access point node is effectively defined in two parts. The first part identifies the access point and the second point identifies the PLMN in which the access point node is provided. The connection is set up between the two networks, that is network A and network B. However, the mobile station which has an international mobile subscriber identity (IMSI) is given, by network A a visitor IMSI (VIMSI). This VIMSI is used in network B. As far as the home location register 32 is concerned, the HLR contains the access point and the identity of the other network (i.e. network B) in which the access point is located. The domain name server has an entry which redirects the access point's name to a GGSN address in the foreign network, for example, network B. This entry may consist of the access point address, the identity of the network with which the access point is associated and the home network of the user. The access operator, that is the operator of network A, and the service owner, that is the operator of network B, do not in preferred embodiments of the present invention need to have a bilateral agreement about access to services. Rather, the agreement may be multilateral. There may be a service broker, for example, the operator controlling the GGSN exchange. The service broker may make agreements separately with one or more access operators and one or more service owners.

In preferred embodiments of the present invention, the access operator, that is the operator of network A, does not need any other subscription management or provisioning action other than to direct a PDP context activation. This can be done with an entry in the domain name server to the GGSN exchange. The access operator may be able to charge for access, for example, with the SGSN based mechanisms as currently defined in the standards. The service operator can rely on the service broker with no subscription management being necessary. The agreement between the service operator and the service broker for admission control can be applied by the GGSN exchange.

As mentioned previously, the privacy of a subscriber can be maintained. The access operator does not need to reveal more than is necessary to the operator of network B. Network B and applications connected to the access operator, without the need to know details of the individual subscriber, are able to optimize, adapt and customize content according to the needs of a subscriber and the specific user context. VIMSI or group identity can be used in embodiments of the invention.

Embodiments of the present invention can be used with a grouping apparatus which is incorporated in the GGSN exchange. This is however, optional. In some embodiments of the present invention, a grouping apparatus with mapping into a single user identity can be used. The access attributes are analyzed by the grouping apparatus to find the group of access cases which matches the access attributes. In this document, this group is called the group identity.

The group identity is the common identity of users who are considered to behave in a similar way from the service point of view. The attributes, which are used to find out the similarity, may be static (e.g. subscription attributes), dynamic (location, current time, current mobility, etc.), or behavior history based (usage of services, mobility etc.). The method to determine the similarity can be manual, automated, or semi-automated. Mathematical methods like PLS (projection to latent structures) or other statistical multi variable modeling methods can be used.

In addition to the subscriber and access information available to the access network, a subscriber may be allowed to define a user profile to be used as an additional input to the grouping apparatus. The user defined profile enables the user to act and select roles with respect to the applications and/or services. In the embodiments of the present invention, the user-defined profile may be seen as one of the access attributes.

Part of the access attributes used as input information for the grouping apparatus may be collected from the access network (network A). In a GPRS access network, this may include information available in the GGSN, SGSN, HLR, base station controller, radio network controller and location server.

Location and mobility information is one type of information. Use of other services (phone calls, short messages, other packet based services like multi media messaging) is another type of information known by the network.

Additional access attributes may be extracted from the user plane traffic. Packet look up may be used to extract details like destination IP address, application port number, the URL in the HTTP request, the cookie included in the request and the like. One particular example of access attributes is the identity and property of the requested content, in for example a browsing application. The grouping information created by the grouping apparatus may be used to find out the service entity best suited to serve the user. The group identity is typically passed to the server or application server. The subscriber can be made aware of the group identity. Additionally the subscriber can be informed about the relative position of the user in the group and changes in the relative position of the user within the group. The access attributes may be used to maintain the grouping apparatus in an automated way. The grouping apparatus may be maintained in background or real time mode. The information about the “relative position in the group” can be service specific user grouping with static subscriber profile, location and concurrent/recent use of other services. For instance, the system may indicate a specific user's services by providing comments such as “Thank You for connecting to our service: Your profile and use context are typical for this service”, “You belong to a small subset of subscribers who use this service in a specific use context”, or “You are not a typical user of this service”. Technically this kind of characterization can be made based on the output of the grouping apparatus. The same information can be used to analyze the success of the service within the intended target group.

In the case of multivariable modeling, the group identity is based on clustering of samples from the results base which is typically a two dimensional results space. The grouping may be based on the given distance at the result plane. The grouping apparatus may also be maintained manually or by some computational system. The group identity produced by the grouping apparatus can be defined by identifying a set of reference users for the group. This enables an automated maintenance of the grouping apparatus. When using the multivariable modeling for the grouping apparatus, the actual location and movement of the group on the result plane can be defined as the movement of the access cases of the reference users, if the access cases of a reference user do not match particularly well the center of gravity or some average measure of the group, the reference user can be removed.

Selection of a reference user is typically done manually when establishing the group. New reference users may be assigned based on producing the access case which matches well the center of gravity of the group.

In addition, to map the access case to a group identity, the grouping apparatus can predict the values of the access attributes not explicitly known for that access case. The prediction can be based on multivariable correlation of access cases and the capability of, for example, a PLS (projection to latent structures) method to predict the variable based on samples (access cases) which include this variable. Based on this prediction capability, the grouping apparatus can be used to implement an automated delivery application where content items are pushed to the subscriber based on the predicted interest of the user. The push application can include subscriber response such as rejection, reading and expressing special interest. The expressed special interest can be used as an access case information to maintain the grouping apparatus used for the prediction.

In embodiments of the present invention, the GGSN exchange can be implemented in a manner similar to a GGSN.

In embodiments of the present invention with the use of the GGSN exchange, services hosted in a foreign network, i.e. network B, may become virtual services of the own network of the user, i.e. network A. Preferably the HLR works as currently proposed in the proposed standards. The roaming service subscribers may be seen as virtual users in the visited network. Accordingly, there is no need for two IP networks to be managed in a coordinated way, if a GGSNe is used as a proxy to isolate the two networks (in GTP-C and GTP-U).

In one alternative embodiment of the present invention, the mobile station can use an access point node in a VPLMN (Visited PLMN). The DNS (Domain Name Server) will be configured so that one access point node address is mapped to an IP address elsewhere. Authorization is based on the HLR or tunneling or traffic from a particular APN in one GGSN to another operator.

The GGSN exchange enables the two networks to continue to operate with very little or no visibility to the other network. This visibility is not needed on IP level (IP connectivity, routing protocols, sharing DNS entries). The visibility can also be avoided in terms of packet core topology: the SGSN and GGSN entities are hidden by the GGSN exchange.

The GGSN exchange is such that you may only need to work at the IP level. The exchange of data is at the IP level. Instead of having a connection, the GTS protocol connection level is used.

The VPN can be a proprietary implementation or implementation e.g. on top of MPLS (Multiprotocol Label Switching) or an Ipsec (IP Security Protocol), where the transit network can be on the IP level only: no GTP (GPRS Tunneling Protocol) awareness of any kind is required.

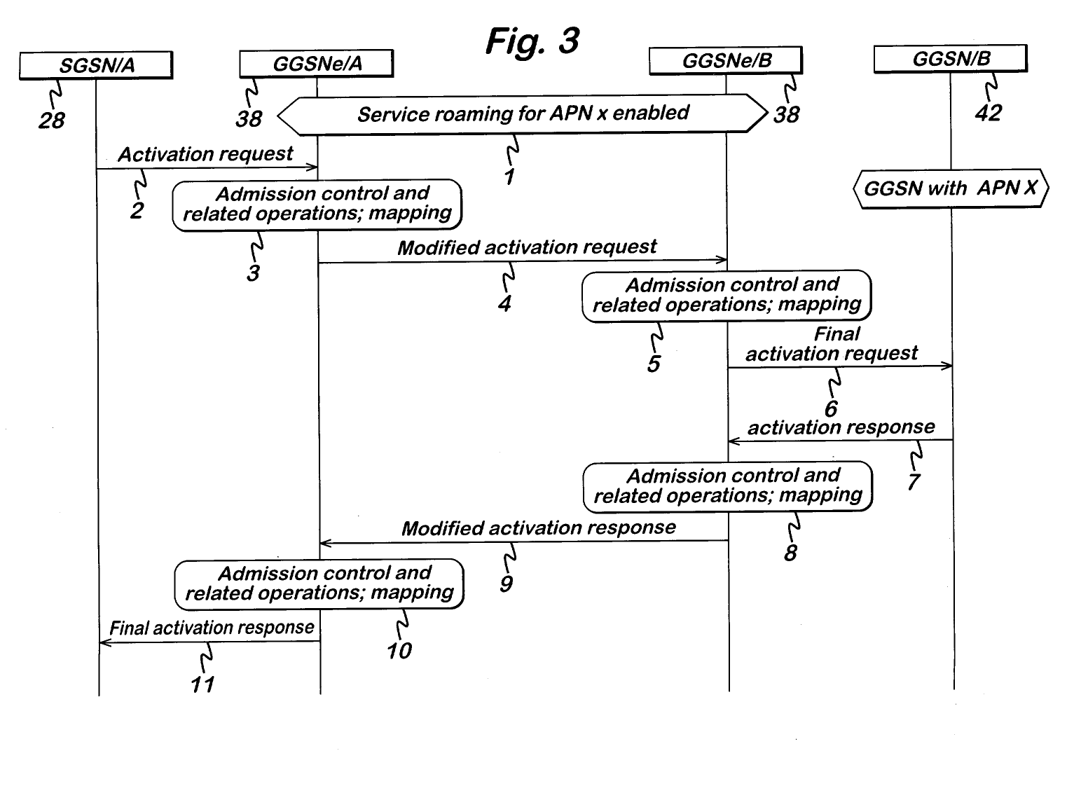

Reference is now made to FIG. 3 which shows a signaling flow for use in embodiments of the present invention. The entities shown in FIG. 3 are marked with the same references as in FIG. 2. In step 1, service roaming is enabled between the two ends of the GGSN exchange; that is, it is possible for a user in network A to obtain a service provided by network B.

In step 2, the SGSN of network A sends an activation request to activate service roaming. The GGSN exchange at the network A side carries out admission control and related operations and mapping in step 3, as discussed previously.

In step 4, a modified activation request is sent from the network A side of the GGSN exchange to the network B end. The GGSN exchange at the network B side carries out admission control and related operations and mapping in step 5, as discussed previously.

In step 6 a final activation request is sent to the GGSN of network B with a response being sent in step 7. The GGSN exchange at the network B side carries out admission control and related operations and mapping in step 8, as discussed previously, taking into account feedback from the GGSN 42.

In step 9, a modified activation request is sent from the network B side of the GGSN exchange to the network A end. The GGSN exchange at the network A side carries out admission control and related operations and mapping in step 10, as discussed previously, taking into account feedback from network B

The final activation response is sent from the GGSN exchange to the SGSN of network A in step 11.

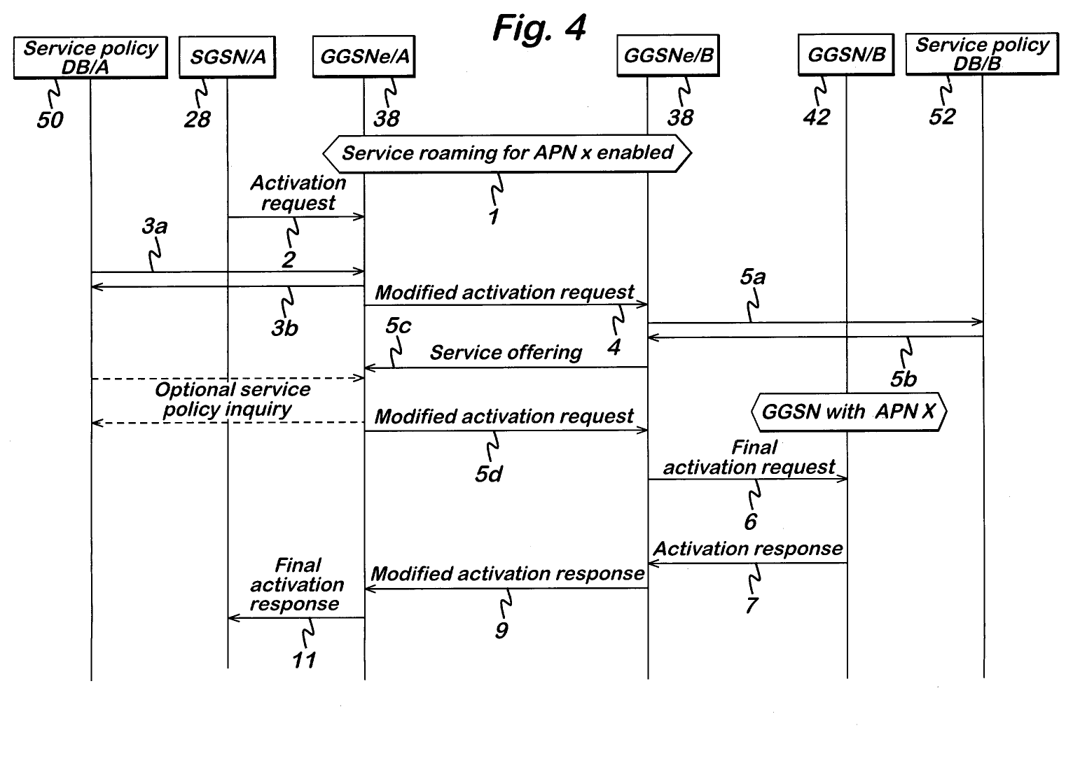

Reference is made to FIG. 4, which shows a modified version of FIG. 3. The embodiment shown in FIG. 4 uses a service policy database 50 in network A and a service policy database 52 in network B. Those steps which are the same as in FIG. 3 are referred to with the same number. Steps 1 and 2 are as in FIG. 3. In steps 3a and 3b, information is sent between the database and the GGSN exchange, network A end. In step 3a the information is sent from the database and, in step 3b, it is sent from the GGSN exchange.

Step 4 is as in FIG. 3. In steps 5a and 5b, information is sent between the database in network B and the GGSN exchange, network B end. In step 5a the information is sent to the database and, in step 5b, it is sent to the GGSN exchange. In step 5c, a service is offered from the network B side of the exchange to the network A side. In step 5d, a modified activation request is sent from the network A side of the exchange to the network B side.

Steps 6 and 7 are as in FIG. 3, There is no step 8 in FIG. 4 as in FIG. 3, because this step has been replaced by the steps 5a-d. Step 9 is as in FIG. 3 as is step 11. There is no step 10 in FIG. 4 which corresponds to Step 10 in FIG. 3.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A communication system comprising:
at least one first network and at least one second network,
at least one user equipment attached to said at least one first network; and
allowing means for allowing said at least one user equipment to access a service via said at least one second network.

2. A system as claimed in claim 1, wherein said at least one user equipment is arranged to access said service via an access point.

3. A system as claimed in claim 1, wherein at least one of said at least one first network and said at least one second network is provided with a packet switched connection.

4. A system as claimed in claim 1, wherein said allowing means comprises an entity connected at one end to the at least one first network and at a second end to the at least one second network.

5. A system as claimed in claim 1, wherein said allowing means comprises at least two entities.

6. A system as claimed in claim 5, wherein at least one entity is connected to the at least one first network and the at least one entity is connected to the at least one second network.

7. A system as claimed in claim 1, wherein said allowing means is configured to check if the at least one user equipment is allowed to access said service.

8. A system as claimed in claim 1, wherein said allowing means is configured to check with an operator of at least one of the at least one first network and the at least one second network to determine if the at least one user equipment is allowed to access said service.

9. A system as claimed in claim 1, wherein said allowing means is configured to check whether resources are available for the at least one user equipment to access said service.

10. A system as claimed in claim 1, wherein a storing means is provided for storing information relating to service level agreements with an operator of at least one of said at least one first network and said at least one second network.

11. A system as claimed in claim 1, wherein a service broker is provided, said service broker being configured to make agreements with an operator of at least one of said at least one first network and said at least one second network.

12. A system as claimed in claim 1, wherein in at least one of said at least one first network and said at least one second network is configured to operate in accordance with a GPRS standard.

13. A system as claimed in claim 12, wherein said service is accessed via a GGSN of the at least one second network.

14. A system as claimed in claim 12, wherein said allowing means is connected to an SGSN of the at least one first network.

15. A system as claimed in claim 12, wherein said allowing means includes one end connected to the at least one first network to provide a GGSN function.

16. A system as claimed in claim 12, wherein said allowing means includes an end connected to the at least one second network to provide an SGSN function.

17. A system as claimed in claim 1, wherein an identity provider is provided to provide the at least one user equipment with an identity for use in said at least one second network, wherein said identity for use in said at least one second network being different from an identity used by said at least one user equipment in said at least one first network.

18. A system as claimed in claim 17, wherein said identity for a user in the at least one second network is such that the at least one second network is unable to determine a true identity of a user.

19. A system as claimed in claim 17, wherein said identity for use in said at least one second network comprises at least one of a VIMSI and a group identity.

20. A system as claimed in claim 1, wherein said at least one user equipment is attached to said at least one first network via a wireless connection.

21. A system as claimed in claim 1, wherein said at least one user equipment is permitted to attach to said at least one first network when used in association with a user identity.

22. A communication system comprising:
at least one first network and at least one second network;
at least one user attached to said at least one first network; and
an entity for allowing said at least one user to access a service via said at least one second network.

23. A system as claimed in claim 22, wherein said at least one user comprises user equipment in conjunction with a user identity.

24. A method of communication in a system comprising at least one first network and at least one second network, said method comprising the steps of:
attaching at least one user equipment to at least one first network; and
allowing said at least one user equipment to access a service via at least one second network.

25. An apparatus for use in a communications system comprising a first network and a second network, said apparatus being configured to be connected to said first network and said second network, said apparatus further being configured to permit a user attached to one of said first network and said second network to access a service provided by another of said first network and second network.

26. Apparatus as claimed in claim 25, wherein said apparatus comprises a first entity connected to the first network and a second entity connected to the second network.

27. Apparatus as claimed in claim 25, wherein said apparatus comprises a single entity connected at one end to the first network and at another end to the second network.

28. Apparatus as claimed in claim 25, wherein said apparatus is configured to check with an operator of the first network and the second network to determine if user is allowed to access said service.

29. Apparatus as claimed in claim 25, wherein said apparatus has an end which connects to the second network to provide an SGSN function.

30. Apparatus as claimed in claim 25, wherein said apparatus has one end which connects to the first network to provide a GGSN function.

31. Apparatus as claimed in claim 25, wherein said apparatus is configured to check whether resources are available for the user to access said service.

32. Apparatus as claimed in claim 25, wherein allowing means is configured to check if the user is allowed to access said service.
